(19) United States
(12) Patent Application Publication
(10) Pub. No.: US 2012/0186842 A1
(43) Pub. Date: Jul. 26, 2012

(54) DRILL HAMMER AND/OR CHIPPING HAMMER DEVICE

(75) Inventors: Christian Wiedemann, Wiernsheim (DE); Achim Duesselberg, Kirchheim Unter Teck (DE)

(73) Assignee: Robert Bosch GmBh, Stuttgart (DE)

(21) Appl. No.: 13/393,378

(22) PCT Filed: Jul. 16, 2010
(86) PCT No.: PCT/EP2010/060318

§ 371 Date: Apr. 11, 2012

(30) Foreign Application Priority Data
Sep. 1, 2009 (DE) 102009029055.9

(51) Int. Cl. B25D 17/06

(52) U.S. Cl. 173/48

(57) ABSTRACT

A drill hammer and/or a chipper hammer device includes a hammer mechanism having a drive unit and a transmission unit. The transmission unit transmits a drive torque from a motor to the hammer mechanism. The transmission unit includes at least one planetary drive. A drive element of the drive unit is disposed on a transmission element of the planetary drive.

### PRIOR ART

A drill hammer and chipping hammer device with a hammer percussion mechanism and with a gear unit for transmitting a drive torque from an electric motor to the hammer percussion mechanism is known. The gear unit has in this case spur wheels which are in engagement with one another.

### DISCLOSURE OF THE INVENTION

A drill hammer and/or chipping hammer device with a hammer percussion mechanism which has a drive unit, and with a gear unit for transmitting a drive torque from a motor to the hammer percussion mechanism, the gear unit comprising at least one planetary gear, and a drive element of the drive unit being arranged on a gear element of the planetary gear, is proposed. In this context, a “hammer percussion mechanism” is to be understood, in particular, to mean a percussion mechanism with a beater which can be accelerated over a travel in the beating direction before it impinges onto a component in order to trigger a beating pulse, such as, preferably, a pneumatic percussion mechanism in which a beater can be driven by a piston via a gas cushion, or a mechanical percussion mechanism in which a beater can be accelerated by a mechanical arrangement, such as, in particular, a spring arm. A “planetary gear” is to be understood, in particular, to mean a gear which has at least one planet which is connected to a planet carrier and which is coupled outwardly in the radial direction to a ring wheel and/or inwardly in the radial direction to a sun wheel and therefore has, in particular, a plurality of coaxial shafts. The sun wheel, the planet and/or the ring wheel may be formed by round gear wheels or by mutually coordinated nonround gear wheels. A plurality of planetary gears may be connected one behind the other and/or a plurality of steps may be interposed between planet wheel and ring wheel. The drive unit may be formed by various units which seem expedient to a person skilled in the art, such as by a wobble bearing unit in which a wobble element is mounted in a bearing plane which is tilted to an axis of rotation by an angle greater than zero, such as, in particular, in a bearing plane spanned by a rolling body raceway, a drive unit formed by a cam track unit and/or, especially advantageously, by an eccentric unit which has, in particular, an eccentrically arranged drive element, such as, in particular, an eccentrically arranged drive bolt. An especially simple and robust construction can be achieved by means of an eccentric unit. The drive unit serves particularly for converting a rotational movement into an axial beating movement. Furthermore, “arranged on a gear element” is to be understood in this context to mean, in particular, that the drive element, such as, in particular, a bearing element with a tilted bearing track of a wobble bearing unit or, especially advantageously, an eccentric bolt of an eccentric unit, is connected fixedly to a gear element of the planetary gear, such as, in particular, to a ring wheel, a planet carrier and/or to a planet of the planetary gear.

By means of a corresponding configuration, an advantageous step-up can be achieved by means of an especially space-saving construction, specifically, in particular, when the planetary gear has an input element, such as, in particular, a sun wheel, the axis of rotation of which is arranged at least essentially coaxially to an axis of rotation of a drive element of the hammer percussion mechanism. The term “essentially coaxially” is to be understood, in particular, to mean that the shafts form an angle of less than 30° and preferably of less than 10°. In this case, an “input element” is to be understood, in particular, to mean an element, via which a torque is introduced into the gear unit and the axis of rotation of which is arranged, in particular, coaxially to an axis of rotation of the motor. Furthermore, as a result of the structural configuration, the gear unit can advantageously be designed as a premountable subassembly, and a small load upon a motor shaft can be achieved, and the motor shaft can be designed with a smaller diameter, with the result that the motor can also be made smaller.

In a further refinement of the invention, it is proposed that an axis of rotation of the planetary gear and a beating axis of the hammer percussion mechanism form an angle unequal to zero, that is to say have an orientation deviating from a parallel or coaxial orientation, as a result of which, in particular, even larger motors can advantageously be integrated, specifically, in particular, when the axis of rotation of the planetary gear and the beating axis of the hammer percussion mechanism, in which a beating pulse is transmitted during operation, form an angle greater than 10° and preferably greater than 20°. Especially advantageously, an L form of construction can be achieved, in which the axis of rotation of the planetary gear and the beating axis of the hammer percussion mechanism form at least essentially, that is to say with a deviation of less than 10° and preferably of less than 5°, an angle of 90°.

If at least one gear element of the planetary gear is formed in one piece with a drive element of the hammer percussion mechanism, such as, in particular, with an eccentric element and/or a wobble bearing element, additional components, construction space, weight, outlay in assembly terms and costs can be saved. In this context, “in one piece” is to be understood, in particular, to mean produced in one casting. Basically, however, a multipart form may also be envisaged, in which parts are connected by means of a riveted, welded and/or brazed joint, etc.

In a further refinement of the invention, it is proposed that the drill hammer and/or chipping hammer device has at least one lockup clutch, with the result that undesirably high torques can advantageously be avoided.

Furthermore, it is proposed that the lockup clutch be arranged in the force flux between a planet carrier and an element of the gear unit and/or between a ring wheel and an element of the gear unit, with the result that the lockup clutch can advantageously be integrated simply and in a space-saving way.

If the planetary gear has at least one sealing means which is provided for sealing off a planetary gear inner space, advantageous central lubrication can be achieved. In this context, a “sealing means” is to be understood, in particular, to mean a means which is provided in a directed way for sealing off, such as, in particular, a sealing ring, labyrinth seal, rubber-like sealing means, etc.

In a further refinement of the invention, it is proposed that a ring wheel and a planet carrier of the planetary gear are connected via a bearing connection, that is to say, in particular, at least one ring wheel is mounted via a planet carrier, so that bearing forces of the ring wheel are supported via the planet carrier, and/or at least one planet carrier is mounted via a ring wheel, so that bearing forces of the planet carrier are supported via the ring wheel. By virtue of a corresponding configuration, construction space can advantageously be saved.

Furthermore, it is proposed that the gear element of the planetary gear on which the drive element is arranged be driven, in at least one operating mode, with a superposed rotational movement, so that the drive element executes a linear movement along a beating axis of the hammer percussion mechanism. As a result of a corresponding configuration, components, such as, in particular, pivotably mounted connecting rod elements, weight, construction space and costs can be saved. In particular, the drive element can advantageously be connected directly to a piston of the hammer percussion mechanism. In this case, various gear elements of the planetary gear which seem to be expedient to a person skilled in the art may be acted upon with a superposed rotational movement, but a corresponding configuration can be achieved especially advantageously in a simple way when the gear element is formed by a planet and the drive element of the drive unit is arranged on a planet of the planetary gear.

### DRAWING

Further advantages may be gathered from the following drawing description. The drawing illustrates exemplary embodiments of the invention. The drawing, description and claims contain numerous features in combination. A person skilled in the art will expediently also consider the features individually and combine them into appropriate further combinations.

In the drawing,

FIG. 1 shows a drill hammer and chipping hammer in a side view with a drill hammer and chipping hammer device indicated diagrammatically,

FIG. 2 shows a detail of the diagrammatically illustrated drill hammer and chipping hammer device from FIG. 1,

FIG. 3 shows a detail of an alternative diagrammatically illustrated drill hammer and chipping hammer device having two planetary gears connected in series,

FIG. 4 shows a detail of an alternative diagrammatically illustrated drill hammer and chipping hammer device with an alternative output element,

FIG. 5 shows a detail of a further alternative drill hammer and chipping hammer device in perspective illustration with part sections,

FIG. 6 shows a view of the drill hammer and chipping hammer device from FIG. 5 from below,

FIG. 7 shows a section through the drill hammer and chipping hammer device along the line VII-VII in FIG. 6, and

FIG. 8 shows a view of the drill hammer and chipping hammer device from FIG. 5 from above with a part section.

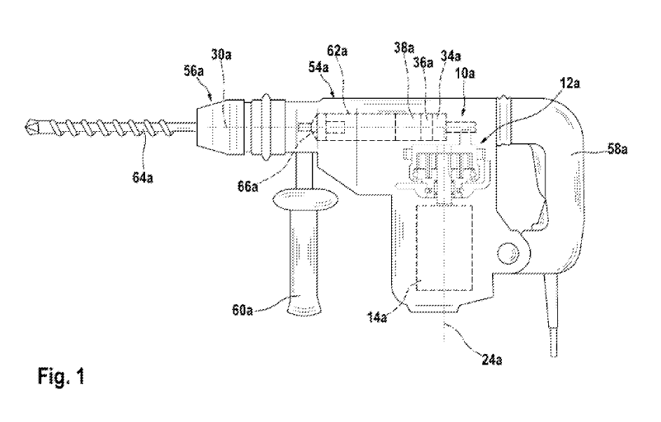

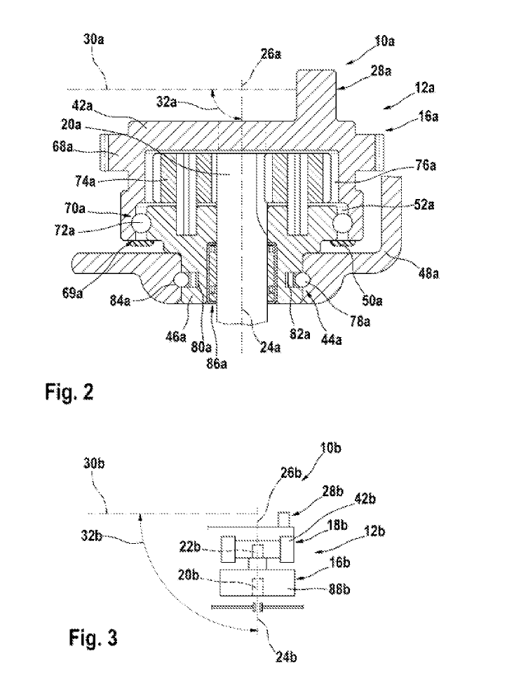

FIG. 1 shows a drill hammer and chipping hammer with a drill hammer and chipping hammer device arranged in a housing 54a. A main handle 58a formed by a bow-type handle is fastened to the housing 54a on a side facing away from a toolholder 56a and an additional handle 60a formed by a post-type handle is fastened to the housing 54a on a side facing the toolholder 56a. The drill hammer and chipping hammer device has a hammer percussion mechanism 10a which comprises a hammer tube 62a, a piston 34a guided in the hammer tube 62a and a beater 38a drivable by the piston via a gas cushion 36a and which acts during operation upon an insert tool 64a via a header 66a. Furthermore, the hammer percussion mechanism 10a comprises a drive unit with a drive element 28a which is formed by an eccentric element and which is intended for converting a rotational movement into an axial stroke movement and consequently for driving the piston 34a in the axial direction of the hammer tube 62a (FIGS. 1 and 2).

The drill hammer and chipping hammer device comprises a gear unit 12a for transmitting a drive torque from an electric motor 14a arranged in the housing 54a to the hammer percussion mechanism 10a or to the drive element 28a. The gear unit 12a has a planetary gear 16a. The planetary gear 16a has an input element 20a which is formed by a sun wheel and the axis of rotation 24a of which is arranged coaxially to an axis of rotation 26a of the drive element 28a of the hammer percussion mechanism 10a. The sun wheel is formed in one piece with a motor shaft of the electric motor 14a. The axis of rotation 24a of the planetary gear or of the sun wheel is arranged coaxially to an axis of rotation of the electric motor 14a. The axis of rotation 24a and a beating axis 30a of the hammer percussion mechanism 10a form an angle 32a of 90°. Basically, however, other angles may also be envisaged. A ring wheel 42a of the planetary gear 16a forms an output element of the gear unit 12a. The drive element 28a is arranged on the ring wheel 42a, specifically, the ring wheel 42a is formed in one piece with the drive element 28a (FIG. 2). Integrally formed on an outer circumference of the ring wheel 42a is a gear wheel 68a which is provided for transmitting a rotational movement from the ring wheel 42a to the hammer tube 62a during drilling operation. The ring wheel 42a is mounted rotatably on a planet carrier 46a of the planetary gear 16a by means of a bearing connection 69a formed by a rolling bearing 70a, the rolling surfaces of the rolling bearing 70a being integrally formed in one piece onto the planet carrier 46a and onto the ring wheel 42a, or the planet carrier 46a and the ring wheel 42a forming rolling surfaces for balls 72a of the rolling bearing 70a. Instead of balls, basically other rolling bodies which seem expedient to a person skilled in the art may also be envisaged. The planet carrier 46a carries a plurality of planets 74a which mesh inwardly in the radial direction with the sun wheel or the input element 20a of the planetary gear 16a and mesh outwardly in the radial direction with an internal toothing 76a of the ring wheel 42a. The planet carrier 46a is supported in a housing element 48a of the gear unit 12a via a lockup clutch 44a of the drill hammer and chipping hammer device. The lockup clutch 44a has lockup balls 78a which are mounted displaceably counter to an annular spring 82a, in radial recesses 80a of the planet carrier 46a and engage outwardly in the radial direction into a latching contour 84a which is integrally formed onto an inner circumference of the ring wheel 42a. If, during operation, a torque to be transmitted by the ring wheel 42a lies below a specific lockup torque, the planet carrier 46a is held fixedly in terms of rotation in the housing element 48a by means of the lockup clutch 44a, and a torque can be transmitted from the ring wheel 42a to the hammer percussion mechanism 10a and/or to the hammer tube 62a. If the lockup torque is reached, the lockup balls 78a are deflected inwardly in the radial direction counter to a spring force in the annular spring 82a and the planet carrier 46a rotates in the housing element 48a. Alternatively, however, the planet carrier 46a could also be formed in one piece with the housing element 48a.

In order to achieve advantageous lubrication, a planetary gear inner space 52a in which, in particular, the planets 74a are arranged is filled with lubricant. The planetary gear inner space 52a is sealed off by means of a sealed-off needle bearing 86a between the input element 20a and the planet carrier 46a and also by means of a sealing means 50a formed by a brushing seal. The annular sealing means 50a is fastened with its radially inner region to the planet carrier 46a and with its radially outer region lies, loaded by an internal tension force, on an end face of the ring wheel 42a.

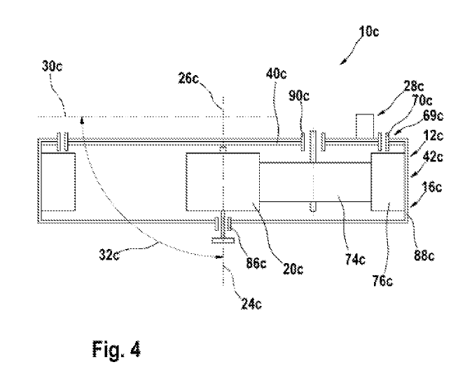

FIGS. 3 and 4 show details of alternative exemplary embodiments. Components, features and functions which remain the same are basically numbered by the same reference symbols. To distinguish the exemplary embodiments, the letters a to c are added to the reference symbols. The following description is basically restricted to differences from the exemplary embodiment in FIGS. 1 and 2. As regards features and functions which remain the same, reference may be made to the description of the exemplary embodiment in FIGS. 1 and 2.

FIG. 2 illustrates a detail of an alternative diagrammatically illustrated drill hammer and chipping hammer device which has a gear unit 12b with two planetary gears 16b, 18b connected in series. The planetary gear 16b has an input element 20b coupled fixedly in terms of rotation to an electric motor, not illustrated in any more detail, and formed by a sun wheel, and a ring wheel 88b. The ring wheel 88b of the planetary gear 16b is coupled fixedly in terms of rotation to an input element 22b of the second planetary gear 18b. The input elements 20b, 22b have a common axis of rotation 24b. Furthermore, the second planetary gear 18b has a ring wheel 42b which forms an output element of the gear unit 12b and which is formed in one piece with a drive element 28b of a hammer percussion mechanism 10b.

FIG. 4 shows a drill hammer and chipping hammer device of a drill hammer and chipping hammer, with a gear unit 12c which has a planetary gear 16c. The planetary gear 16c has an input element 20c which is formed by a sun wheel and the axis of rotation 24c of which is arranged coaxially to an axis of rotation 26c of a drive unit or drive element 28c of the drive unit of a hammer percussion mechanism 10c. The sun wheel and a motor shaft in one piece with the sun wheel are mounted in a ring wheel 42c of the planetary gear 16c by means of a needle bearing 86c. Alternatively, the sun wheel and/or the motor shaft could be mounted in a planet carrier 40c of the planetary gear 16c. The planet carrier 40c of the planetary gear 16c forms an output element of the gear unit 12c. The drive element 28c is arranged on the planet carrier 40c, specifically, the planet carrier 40c is formed in one piece with the drive element 28c. To pick up a torque for driving a hammer tube in rotation, the planet carrier 40c could be connected to a gear wheel or a gear wheel could be integrally formed onto the planet carrier 40c. The planet carrier 40c is mounted rotatably in the ring wheel 42c of the planetary gear 16c by means of a bearing 70c. The planet carrier 40c carries a plurality of planets 74c which mesh inwardly in the radial direction with the sun wheel or the input element 20c of the planetary gear 16c and mesh outwardly in the radial direction with an internal toothing 76c of the ring wheel 42c. The planets 74c are in each case mounted fixedly in terms of rotation on axles which are mounted rotatably in the planet carrier 40c in each case via a bearing 90c. Alternatively, the planets 74c could also be mounted rotatably on the axles and the axles could be arranged fixedly in terms of rotation in the planet carrier 40c. The planetary gear 16c is filled with lubricant and the bearings 70c, 86c, 90c are sealed off. The ring wheel 42c is arranged fixedly in terms of rotation in a housing, not illustrated in any more detail, of a drill hammer and chipping hammer. In order to ensure a lockup function, the ring wheel 42c could be mounted in the housing of the drill hammer and chipping hammer via a lockup clutch, and/or a lockup clutch could be arranged between the planet carrier 40c and the hammer tube.

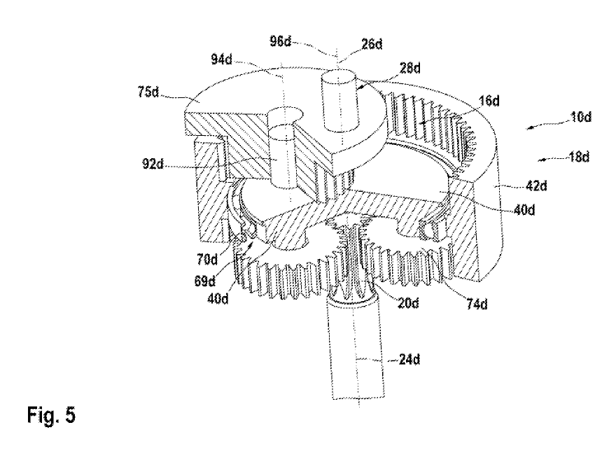

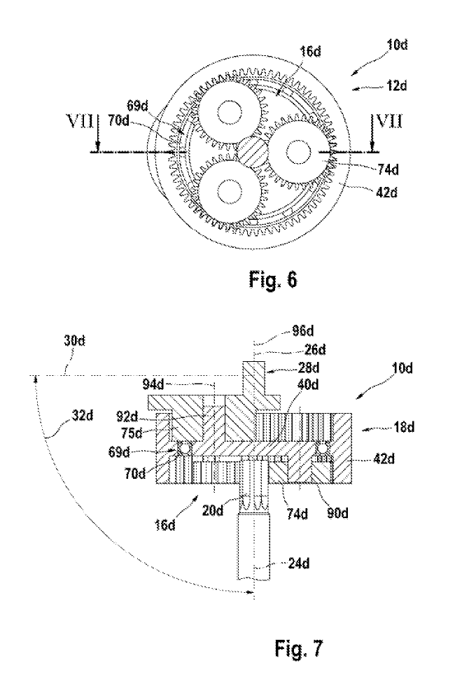

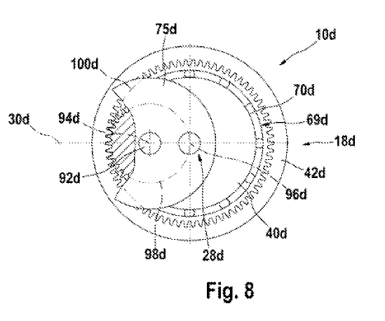

FIG. 5 shows a drill hammer and chipping hammer device of a drill hammer and chipping hammer, with a gear unit 12d which has a planetary gear 16d. The planetary gear 16d has an input element 20d which is formed by a sun wheel and the axis of rotation 24d of which is arranged coaxially to an axis of rotation 26d of a drive unit or a drive element 28d of the drive unit of a hammer percussion mechanism 10d. The planetary gear 16d has a rotatably mounted planet carrier 40d, on which three planets 74d are mounted rotatably on a side facing the sun wheel. The planets 74d mesh inwardly in the radial direction with the sun wheel and outwardly in the radial direction with a ring wheel 42d, fastened fixedly in terms of rotation in a housing, not illustrated in any more detail, of the planetary gear 16d.

The planet carrier 40d of the planetary gear 16d has a driven element 92d on a side facing away from the sun wheel. The driven element 92d is arranged eccentrically to the axis of rotation 24d. The driven element 92d is formed by a bolt formed in one piece with the planet carrier 40d. A planet 75d of the planetary gear 16d is mounted rotatably on the driven element 92d and meshes outwardly in the radial direction with the ring wheel 42d. The drive element 28d is arranged on the planet 75d on a side facing away from the planet carrier 40d.

The drive element 28d is arranged eccentrically to an axis of rotation 94d of the planet 75d about which the planet 75d is mounted rotatably on the driven element 92d. During operation, the planet 75d on which the drive element 28d is arranged is driven with a superposed rotational movement, so that the drive element 28d executes a linear movement along a beating axis 30d. The drive element 28d has a longitudinal axis 96d which runs through a reference circle 98d of the planet 74d and parallel to the axis of rotation 94d of the planet 75d. The reference circle 98d has a diameter which is half as large as a reference circle diameter of a reference circle 100d of the ring wheel 42d in which the planet 75d can roll. By means of the single ring wheel 42d, in which both the planets 74d and the planet 75d mesh, an especially space-saving construction can be achieved. Basically, however, two separate ring wheels could also be provided.

To pick up a torque for driving a hammer tube in rotation, the planet carrier 40d could be connected to a gear wheel or a gear wheel could be integrally formed onto the planet carrier 40d. The planet carrier 40d is mounted rotatably in the ring wheel 42d of the planetary gear 16d by means of a bearing connection 69d formed by a rolling bearing 70d. In order to ensure a lockup function, the ring wheel 42d could be mounted in the housing of the drill hammer and chipping hammer via a lockup clutch, and/or a lockup clutch could be arranged between the planet carrier 40d and the hammer tube.

1. A drill hammer and/or a chipping hammer device comprising:
a hammer percussion mechanism which has a drive unit; and
a gear unit for transmitting a drive torque from a motor to the hammer percussion mechanism,
wherein the gear unit includes at least one planetary gear, and
wherein a drive element of the drive unit is arranged on a gear element of the planetary gear.

2. The drill hammer and/or chipping hammer device as claimed in claim 1, wherein the planetary gear has an input element, the axis of rotation of which is arranged at least essentially coaxially to an axis of rotation of the drive element of the hammer percussion mechanism.

3. The drill hammer and/or chipping hammer device as claimed in claim 1, wherein the hammer percussion mechanism comprises a drive element formed by an eccentric element.

4. The drill hammer and/or chipping hammer device as claimed in claim 1, wherein an axis of rotation of the planetary gear and a beating axis of the hammer percussion mechanism form an angle unequal to zero.

5. The drill hammer and/or chipping hammer device as claimed in claim 1, wherein the hammer percussion mechanism has a piston and a beater drivable by the piston via a gas cushion.

6. The drill hammer and/or chipping hammer device as claimed in claim 1, wherein at least one gear element of the planetary gear is formed in one piece with the drive element of the hammer percussion mechanism.

7. The drill hammer and/or chipping hammer device as claimed in claim 1, further comprising at least one lockup clutch.

8. The drill hammer and/or chipping hammer device as claimed in claim 7, wherein the lockup clutch is arranged in the force flux between a planet carrier and an element of the gear unit and/or between a ring wheel and an element of the gear unit.

9. The drill hammer and/or chipping hammer device as claimed in claim 1, wherein the planetary gear has at least one sealing means which is provided for sealing off a planetary gear inner space.

10. The drill hammer and/or chipping hammer device as claimed in claim 1, wherein a ring wheel and a planet carrier of the planetary gear are connected via a bearing connection.

11. The drill hammer and/or chipping hammer device as claimed in claim 1, wherein the gear element of the planetary gear on which the drive element is arranged is driven, in at least one operating mode, with a superposed rotational movement, so that the drive element executes a linear movement along a beating axis of the hammer percussion mechanism.

12. The drill hammer and/or chipping hammer device as claimed in claim 11, wherein the drive element of the drive unit is arranged on a planet of the planetary gear.

13. A drill hammer and/or chipping hammer comprising:
a drill hammer and/or chipping hammer device including a hammer percussion mechanism and a gear unit,
wherein the hammer percussion mechanism includes a drive unit,
wherein the gear unit transmits a drive torque from a motor to the hammer percussion mechanism,
wherein the gear unit includes at least one planetary gear, and
wherein a drive element of the drive unit is arranged on a gear element of the planetary gear.
